(19) United States
(12) Patent Application Publication
(10) Pub. No.: US 2026/0246161 A1
(43) Pub. Date: Aug. 20, 2026

(54) ANTENNA DEVICE

(71) Applicant: DENSO CORPORATION, Kariya-city (JP)

(72) Inventors: Daiju USHIKOSHI, Nisshin-city (JP); Takuya YAMASHITA, Kariya-city (JP); Shiro KOIDE, Kariya-city (JP)

(21) Appl. No.: 19/641,969

(22) Filed: Apr. 8, 2026

Related U.S. Application Data
(63) Continuation of application No. PCT/JP2024/036226, filed on Oct. 10, 2024.

(30) Foreign Application Priority Data
Oct. 30, 2023 (JP) 2023-185928

(51) Int. Cl. H01Q 21/29; H01Q 9/04

(52) U.S. Cl. CPC H01Q 21/29; H01Q 9/0407

(57) ABSTRACT

An antenna device includes a baseplate, a first antenna configured to operate as a zero-order resonant antenna including a first conductor and a short-circuit element, a second antenna including a second conductor that is arranged to surround the first conductor, and a switching unit configured to switch an antenna to be operated between the first antenna and the second antenna. The second antenna is configured to operate in a same frequency band as the first antenna.

### CROSS REFERENCE TO RELATED APPLICATION

The present application is a continuation application of International Patent Application No. PCT/JP2024/036226 filed on October 10, 2024, which designated the U.S. and claims the benefit of priority from Japanese Patent Application No. 2023-185928 filed in Japan on October 30, 2023. The entire disclosures of all of the above applications are incorporated herein by reference.

### TECHNICAL FIELD

The present disclosure relates to antenna devices.

### BACKGROUND

A relevant art discloses an antenna device that can switch directivity using two patch antennas.

In a relevant art, from the viewpoint of diversity or MIMO (Multiple Input Multiple Output), or the like, there is a need for antenna devices with switchable directivity. On the other hand, a compact size is also required for antenna devices.

### SUMMARY

According to an aspect of the present disclosure, an antenna device includes a baseplate, a first antenna, a second antenna and a switching unit. The first antenna includes a first conductor, which is a flat conductor positioned to face the baseplate, and a short-circuit element electrically connecting the first conductor and the baseplate. The first antenna may be configured to operate as a zero-order resonant antenna, the second antenna may include a second conductor arranged to surround the first conductor, and the switching unit may be configured to switch one antenna to be operated among the first antenna and the second antenna. In the antenna device, the second antenna may be configured to operate in a same frequency band as the first antenna.

### BRIEF DESCRIPTION OF THE DRAWINGS

Objects, features, and advantages of the present disclosure will become more apparent from the following detailed description made with reference to the accompanying drawings, in which:

FIG. 1 is an external perspective view of an antenna device;

FIG. 2 is a cross-sectional view taken along the II – II line of FIG. 1;

FIG. 3 is a block diagram showing a schematic configuration of the antenna device;

FIG. 4 is a diagram showing electric current distribution when a first antenna is operated;

FIG. 5 is a diagram showing a directivity in an XY plane when the first antenna is operated;

FIG. 6 is a diagram showing a directivity in an XZ plane when the first antenna is operated;

FIG. 7 is a diagram showing a directivity in a YZ plane when the first antenna is operated;

FIG. 8 is a diagram showing electric current distribution when a second antenna is operated;

FIG. 9 is a diagram showing a directivity in the XY plane when the second antenna is operated;

FIG. 10 is a diagram showing a directivity in the XZ plane when the second antenna is operated;

FIG. 11 is a diagram showing a directivity in the YZ plane when the second antenna is operated;

FIG. 12 is a diagram showing reflection characteristics of the first antenna and the second antenna at different frequencies;

FIG. 13 is an external perspective view showing an antenna device in a second embodiment;

FIG. 14 is a diagram showing electric current distribution when the first antenna is operated in the second embodiment;

FIG. 15 is a diagram showing a directivity in the XY plane when the first antenna is operated in the second embodiment;

FIG. 16 is a diagram showing a directivity in the XZ plane when the first antenna is operated in the second embodiment;

FIG. 17 is a diagram showing a directivity in the YZ plane when the first antenna is operated in the second embodiment;

FIG. 18 is a diagram showing electric current distribution in the second embodiment;

FIG. 19 is a diagram showing a directivity in the XY plane when the second antenna is operated in the second embodiment;

FIG. 20 is a diagram showing a directivity in the XZ plane when the second antenna is operated in the second embodiment;

FIG. 21 is a diagram showing a directivity in the YZ plane when the second antenna is operated in the second embodiment;

FIG. 22 is a diagram showing reflection characteristics of the first antenna and the second antenna at different frequencies in the second embodiment;

FIG. 23 is an external perspective view showing an antenna device in a third embodiment; and

FIG. 24 is an external perspective view showing an antenna device in a modification example.

### DESCRIPTION OF EMBODIMENTS

The present disclosure is to provide an antenna device having switchable directivity and a compact size.

An antenna device according to an exemplar of the present disclosure includes a baseplate, a first antenna, a second antenna and a switching unit. The first antenna includes a first conductor, which is a flat conductor positioned to face the baseplate, and a short-circuit element electrically connecting the first conductor and the baseplate. The first antenna is configured to operate as a zero-order resonant antenna. The second antenna includes a second conductor arranged to surround the first conductor. The switching unit is configured to switch one antenna to be operated among the first antenna and the second antenna, and the second antenna is configured to operate in a same frequency band as the first antenna.

In the antenna device, a zero-order resonant antenna operating at the same frequency can be formed inside the second antenna made of the second conductor. With a zero-order resonant antenna, the size of a plate conductor (i.e., the first conductor) that is placed opposite to the baseplate can be made compact than that of a patch antenna. Thus, an overall size of the antenna device can be reduced. The antenna device described above is configured so that the antenna to be operated can be switched by the switching unit. Since the first antenna and the second antenna have different configurations, their directivity can also be different. Therefore, as the operating antenna switches, directivity of the antenna also changes. In other words, the above configuration makes it possible to switch directivity while making the antenna device have a compact size.

The present disclosure will be described with reference to the drawings. The present disclosure is not limited to the following embodiments, and various modifications described below are also included in the technical scope of the present disclosure. Further, various other modifications can be made to the present disclosure other than those described below within the scope of not departing from the gist. Various supplements and variations can be combined as appropriate to the extent that no technical contradictions arise. Members having the same function may be indicated with the same symbol and their description may be omitted. If only a part of the configuration is mentioned, the rest of the configuration may be borrowed from the other part of the description.

The expression “parallel” in the present disclosure is not limited to a perfectly parallel state. The “parallel” state includes a tilt of a few degrees to 15 degrees or the like. In other words, the expression “parallel” can include a state of being generally parallel (so-called appropriately parallel state). The expression “vertical” in the present disclosure is also not limited to a completely vertical state, but also includes a state in which it is tilted by several to 15 degrees or the like. In the present disclosure, facing means facing each other with a predetermined distance. The facing state includes a state in which the members are generally facing each other, such as when the members are facing each other at a tilt of about 15 degrees or the like. The facing of the present disclosure may also include a state in which the members are parallel to each other with the members horizontally displaced from each other.

An antenna device 1 of the present disclosure is used, for example, in a state attached to a movable object such as a vehicle. The antenna device 1 may be mounted on the roof of the vehicle, on an upper side of the windshield, on the dashboard, on the pillars, on the door panels, on the bumpers, or the like. The antenna device 1 could be used in connection with an ECU (Electronic Control Unit) for communication installed in a vehicle. The ECU can use a signal received by the antenna device 1, and can also input a transmission signal to the antenna device 1.

The antenna device 1 includes a first antenna 10 and a second antenna 20, as described below. Further, the first antenna 10 and the second antenna 20 are configured to operate at the same frequency. The antenna device 1 may be used only for either transmission or reception. Since the transmission and reception of radio waves are reversible, a configuration capable of transmitting radio waves of a certain frequency is the one that is also capable of receiving radio waves of the same frequency. The term “transmission/reception” in the following means at least one of transmission and reception. In the following, the frequency at which the antenna device 1 is targeted for transmission or reception is referred to as the target frequency. The target frequency may be paraphrased as the operating frequency. The antenna device 1 can also transmit and receive radio waves not only at the target frequency, but also at frequencies within a predetermined range defined with respect to the target frequency. In the present disclosure, the frequency band in which the antenna device 1 can transmit or receive is also referred to as a target frequency band.

The antenna device 1 in the present embodiment is configured to transmit and receive radio waves in the frequency band used in cellular communications. In other words, the antenna device 1 is configured as an antenna for data communication with wireless base stations that constitute 4G or 5G mobile communication systems. The target frequency is 3.75 GHz as an example here.

In other forms, the antenna device 1 may be configured to transmit and receive radio waves in the frequency bands used in short-range wireless communications, such as Bluetooth Low Energy (Bluetooth is a registered trademark), Wi-Fi (registered trademark), ZigBee (registered trademark), UWB (Ultra Wide Band) and the like. Of course, the target frequency can be designed as needed, such as 300 MHz, 760 MHz, 850 MHz, 900 MHz, 1.17 GHz, 1.28 GHz, 1.55 GHz, 2.45 GHz, 5.9 GHz, and the like.

The antenna device 1 may be applied to Virtual MIMO. The virtual MIMO is a technology that simultaneously transmits data by switching the directivity of the antennas at high speed while sampling at twice the rate of the conventional MIMO. Of course, the antenna device 1 of the present disclosure is not limited to the Virtual MIMO, but may be applied to various purposes.

In the following, “λ” represents the wavelength of the radio wave of the target frequency (hereinafter also referred to as the target wavelength). For example, “λ/2” and “0.5λ” mean half the length of the target wavelength, and “λ/4” and “0.25λ” mean a quarter of the target wavelength. In the example of the dimensions of the components of the antenna device 1, the expression using λ can be understood as the electrical length. The electrical length here is an effective length, taking into account the fringing electric field, the wavelength shortening effect of the dielectric and the like. The electrical length is sometimes called as the effective length. Of course, for the part that is not subject to wavelength shortening effects, and the like, λ can be understood as the length in vacuum or air. The description of λ/2 in the present disclosure may be understood as a length that falls within λ/2 ± 20%. The approximate λ/4 may be understood as a length that falls within λ/4 ± 20%. The description of λ/2 and λ/4 may also be understood as approximate λ/2 and λ/4, unless otherwise specified, such as “just” or the like.

The antenna device 1 is connected to a radio 50 via a communication cable, and signals received by the antenna device 1 are sequentially output to the radio 50. The radio 50 uses the signals received by the antenna device 1, and provides high-frequency electric power to the antenna device 1 corresponding to the transmission signal. The communication cable may be, for example, a coaxial cable. Of course, the communication cable may also be configured as other power feeding lines, such as feeder wires or the like.

### First Embodiment

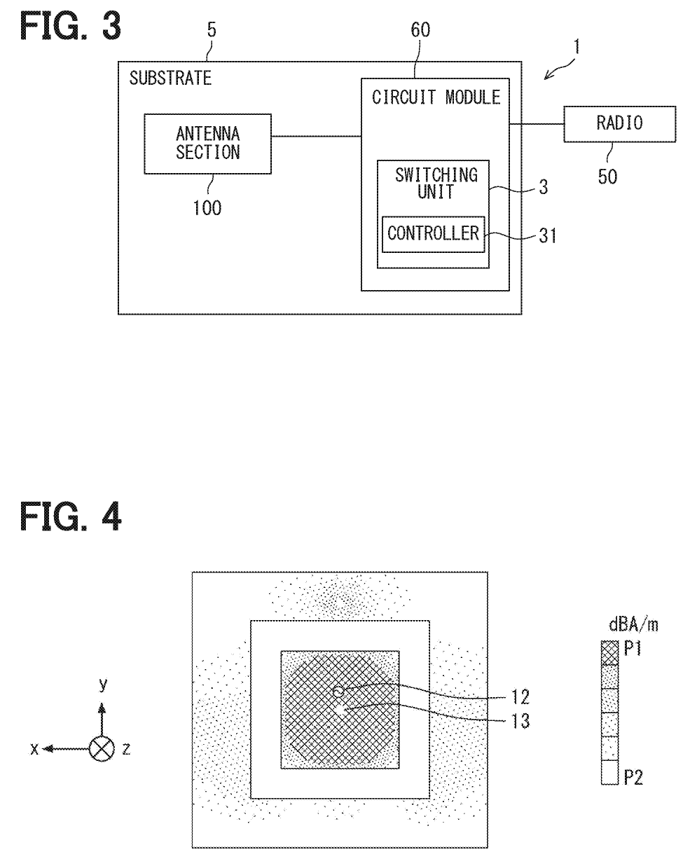

The schematic configuration of the antenna device 1 is described below. As shown in FIG. 3, the antenna device 1 has a circuit module 60, an antenna section 100, and a substrate 5. The circuit module 60 includes a switching unit 3. The circuit module 60 is connected to the radio 50 via a communication cable.

The circuit module 60 is a circuit that performs signal processing for at least one of transmitting a signal and receiving a signal. The circuit module 60 is configured to perform at least one of modulation, demodulation, frequency conversion, amplification, digital-to-analog conversion, and detection. The circuit module 60 processes the signals received by the antenna section 100, and transmits the processed signals to the radio 50. The circuit module 60 may be configured to perform signal/data processing for the Virtual MIMO.

The antenna section 100, the circuit module 60, and the switching unit 3 are mounted on the substrate 5. The circuit module 60 and the switching unit 3 may be mounted on the substrate 5 that is included in the antenna section 100.

The antenna section 100 is an electrical configuration as an antenna. The antenna section 100 has a baseplate 2, the first antenna 10, and the second antenna 20. The first antenna 10 includes a first conductor 11, a first power supply point 12, and a short-circuit element 13. The second antenna 20 includes a second conductor 21 and a second power supply point 22.

The substrate 5 is a plate-shaped member with a predetermined thickness h, made of an electrical insulating material such as resin. The substrate 5 is a member for arranging the first conductor 11 and the second conductor 12 at a predetermined spacing h so that they face the baseplate 2. Therefore, the shape of the substrate 5 is not limited to a plate shape, but may also be any other shape.

The substrate 5 has a first surface 5a and a second surface 5b. The first surface 5a is a surface to which the first conductor 11 and the second conductor 12 are attached. The second surface 5b is a surface to which the baseplate 2 is attached. The first surface 5a may be paraphrased as a top surface. The second surface 5b is an opposite surface of the first surface 5a. The second surface 5b may be paraphrased as a back surface or a bottom surface. The direction orthogonal to the substrate 5 is the vertical direction for the antenna device 1. The upward direction is a direction oriented from the second surface 5b to the first surface 5a of the two surfaces provided by the substrate 5.

The baseplate 2 is a rectangular plate (including foil) made of copper or other conductive material. The baseplate 2 provides ground potential (earth potential) at the first antenna 10 and the second antenna 20. The baseplate 2 may be electrically connected to a ground pattern, not shown, that provides ground potential for the printed circuit board. The baseplate 2 is at least larger than the first conductor 11 and the second conductor 12, and its shape is not limited to a rectangular shape.

In the following, the concept of a right-handed three-dimensional coordinate system with X, Y, and Z axes will be introduced as appropriate, for the description of the configuration of the antenna device 1. The X axis and Y axis are set so that the XY plane is parallel to the baseplate and orthogonal to each other. The Z axis is orthogonal to the substrate/baseplate, and is set so that the upward direction of the substrate/baseplate is a positive direction. In the present embodiment, the X axis is parallel to a shorter side of the baseplate or substrate, and the Y axis is parallel to a longer side. An X axis direction corresponds to a second direction, and the Y axis direction corresponds to a first direction, in the present embodiment.

First Antenna 10

The first antenna 10 is configured to operate as a zero-order resonant antenna at the target frequency. The first conductor 11 is a rectangular plate (including foil) made of a conductor such as copper. The first conductor 11 has four sides. The first conductor 11 is positioned to face the baseplate 2, i.e., to be in parallel with the baseplate 2 through the substrate 5. Here, the shape of the first conductor 11 is square. In other embodiments, the planar shape of the first conductor 11 may be a circle, a regular octagon, a regular hexagon, or the like. Further, the first conductor 11 may also be rectangular or oblong in shape. It may be more preferable for an opposing conductor plate to be a point-symmetrical shapes, such as circles, squares, rectangles, and parallelograms.

The dimensions of the first conductor 11 are designed to operate a zero-order resonant antenna at the target frequency in cooperation with the short-circuit element 13. In other words, the area of the first conductor 11 is set to an area that forms a capacitance that is parallel-resonant at the target frequency with the inductance component provided by the short-circuit element 13 described below. Therefore, the area of the first conductor 11, i.e., a first lateral length L1x, which is the length of the side of the first conductor 11 along the X axis direction, and a first longitudinal length L1y, which is the length of the side of the first conductor 11 along the Y axis direction, are set appropriately based on the inductance component and the target frequency provided by the short-circuit element 13. The first longitudinal length L1y corresponds to the length of the first conductor 11 in the first direction, and the first lateral length L1x corresponds to the length of the first conductor 11 in the second direction.

For example, the first lateral length L1x of the first conductor 11 is set to be shorter than λ/2 of a given frequency. The first lateral length L1x may be set to 8 mm, 10 mm or the like. The first longitudinal length L1y is set to be shorter than a length L2y of the side of the second conductor 21 of the second antenna 20 along the Y axis direction, which is described below. The first longitudinal length L1y is set to, for example, 8 mm, 10 mm or the like.

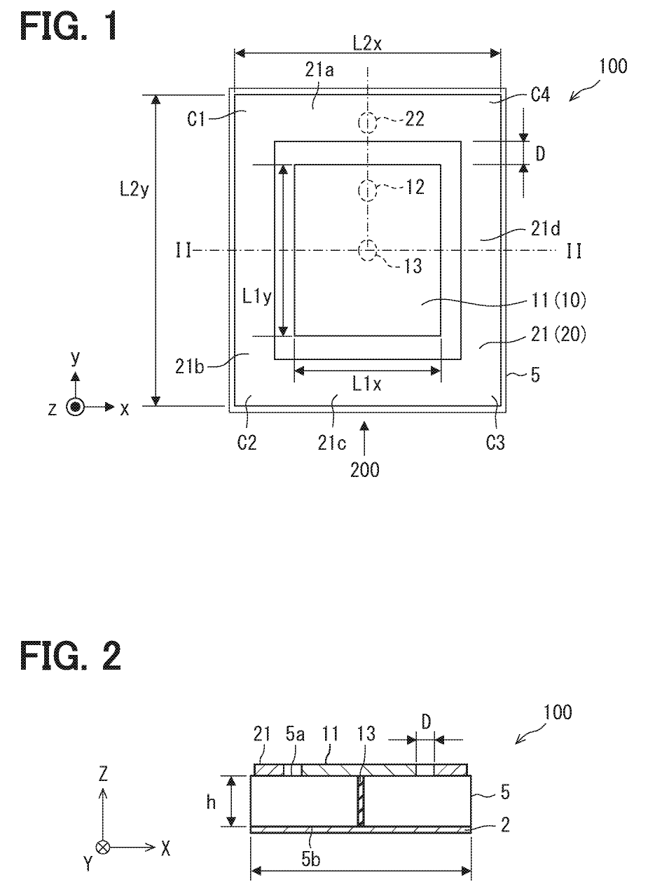

The short-circuit element 13 is a part for the electrical connection between the first conductor 11 and the baseplate 2, as shown in FIG. 1. The short-circuit element 13 is provided at a central portion of the first conductor 11. The central portion here may be an area that is within a predetermined distance (e.g., 3 mm) from the center of the first conductor 11. The central portion may be understood as the area closer to the center than the sides of the first conductor 11. Note that the center of the first conductor 11 may be an intersection of diagonal lines of the first conductor 11. In the following, the center of the first conductor 11 is also referred to as the conductor plate center.

FIG. 2 shows a cross-section of the antenna device 1 at the II – II line parallel to the X axis direction through the short-circuit element 13, viewed from the direction of an arrow 200. The short-circuit element 13 can be realized by a conductive pin (hereinafter also described as a short-circuit pin). The thickness and length of the short-circuit element 13 can adjust the inductance provided by the short-circuit element 13. Note that the formation position of the short-circuit element 13 is not required to strictly coincide with the center of the conductor plate. The short-circuit element 13 may be off-center of the conductor plate.

The first power supply point 12 is formed at an arbitrary position on the first conductor 11. The first power supply point 12 is a part where an inner conductor of the coaxial cable is electrically connected to the first conductor 11. The distance between the first power supply point 12 and the short-circuit element 13 may be such that the impedance of a power supply line and the antenna device 1 can be matched at the target frequency, and the first power supply point 12 can be arranged anywhere within a range that satisfies such condition.

A variety of power supply methods can be used to supply electric power for the first conductor 11, such as a direct connection power supply method, an electromagnetic coupling method and the like. The direct connection power supply method is a method in which the power supply line is directly connected to the first conductor 11. The power supply line means a conductive member electrically connected to the inner conductor of the coaxial cable or to signal input/output terminals of a transmitter/receiver circuit. The power supply line may be a microstrip line. The power supply line may include conductor pins, vias, and the like. In the direct connection power supply method, the connection point between the power supply line and the first conductor 11 corresponds to a first power supply point 12. The electromagnetic coupling method means a power supply method using electromagnetic coupling between a microstrip line or the like for power supply and the first conductor 11.

Other than the above, the first antenna 10 may include an impedance matching element (not shown) that electrically connects the first power supply point 12 to the baseplate 2. Impedance matching here means that the impedance value on the sender side that sends out the signal and the impedance value on the receiver side that receives the signal are identical. Note that when the impedance is not matched, the gain may decrease due to reflections, and the like, and thus the device utility as an antenna may deteriorate.

Second Antenna 20

The second antenna 20 is a conductor member configured to operate as a patch antenna. The second conductor 21 is realized using a conductor such as copper. The second conductor 21 has a frame shape surrounding the first conductor 11 with a predetermined spacing D. The predetermined interval D is set to an interval that no electric current flows from the first conductor 11 to the second conductor 21 when electric power is supplied to the first power supply point 12 to operate the first antenna 10. Alternatively, the spacing D is set to a value such that even if electric current flows from the first conductor 11 to the second conductor 21, the amount of electric current flowing will not affect the operation of the first antenna 10. The predetermined spacing D may be set to 1 mm, 2 mm, 3 mm, or the like for example. Such a second conductor 21 may be understood as a conductor plate (i.e., a conductor film) with a central portion cut out therefrom. The second conductor 21 is positioned to face the baseplate 2 through the substrate 5.

The outer shape (in other words, the contour shape) of the second conductor 21 is rectangular. In the present embodiment, it is a rectangle. In other embodiments, the outer shape of the second conductor 21 may be a shape other than a rectangle, such as an oblong oval or the like. The outer shape of the second conductor 21 may be square, as described below. The outer shape of the second conductor 21 may also be a circle, a regular octagon, a regular hexagon, or the like.

The second lateral length L2x, which is the length of the side of the second conductor 21 in the X axis direction, is set longer than the first lateral length L1x. The second lateral length L2x is set to, for example, 20 mm, 22 mm or the like. The second longitudinal length L2y, which is the length of side of the second conductor 21 along the Y axis direction, is a value corresponding to the length of λ/2 of the radio wave at a given frequency. The second longitudinal length L2y is set longer than the first longitudinal length L1y. The second longitudinal length L2y is set to, for example, 18 mm, 20 mm or the like. The second longitudinal length L2y corresponds to the length of the second conductor 21 in the first direction, and the second lateral length L2x corresponds to the length of the second conductor 21 in the second direction.

The second conductor 21 includes a first frame section 21a, a second frame section 21b, a third frame section 21c, and a fourth frame section 21d as four sides thereof. Among the two sides parallel to the X axis, the first frame section 21a is the side relatively provided on the positive side of the Y axis, and the third frame section 21c is the side opposite to the first frame section 21a. Among the two sides parallel to the Y axis, the fourth frame section 21d is the side relatively provided on the positive side of the X axis, and the second frame section 21b is the side opposite to the fourth frame section 21d.

For convenience, the four corners of the second conductor 21 are referred to as a first corner C1, a second corner C2, a third corner C3, and a fourth corner C4. The first corner C1 is a corner to which the first frame section 21a and the second frame section 21b are connected. The second corner C2 is a corner to which the second frame section 21b and the third frame section 21c are connected. The third corner C3 is a corner to which the third frame section 21c and the fourth frame section 21d are connected. The fourth corner C4 is a corner to which the fourth frame section 21d and the first frame section 21a are connected.

The second power supply point 22 is provided at a position near the center of the first frame section 21a in the X axis direction. The second power supply point 22 is a part where the inner conductor of the coaxial cable is electrically connected to the second conductor 21.

Switching Unit 3

The switching unit 3 is configured to switch the antenna to be operated among the first antenna 10 and the second antenna 20. The switching unit 3 includes a switch for switching the power supply point to be supplied (in other words, enabled) among the first power supply point 12 and the second power supply point 22, and a controller 31 that controls the on/off of the switch. The controller 31 may be an IC (Integrated Circuit), FPGA (Field Programmable Gate Array), or CPU (Central Processing Unit). Switching the power supply point corresponds to switching the antenna to be operated among the first antenna 10 and the second antenna 20. The controller 31 selectively enables (supplies electric power to) either the first power supply point 12 or the second power supply point 22. Due to the spacing D between the first conductor 11 and the second conductor 12, only the first antenna 10 operates when the first power supply point 12 receives electric power, and only the second antenna 20 operates when the second power supply point 22 receives electric power. The switching unit 3 may be not provided in the circuit module 60. The switching unit 3 may also be independently provided on the substrate 5.

<Zero-Order Resonant Antenna and Its Operation>

The operation of the first antenna 10 is first described. The first antenna 10 is configured as a zero-order resonant antenna at the target frequency. The zero-order resonant antenna may also be referred to as a metamaterial antenna. The zero-order resonant antenna is an antenna that utilizes zero-order resonance, a phenomenon in the dispersion characteristics of metamaterials that resonates at a frequency where the phase constant β is zero. In the zero-order resonant antenna, the antenna is characterized by the LC parallel resonance between the capacitance (C) formed between the baseplate 2 and the first conductor 11 and the inductance (L) provided by the short-circuit element 13. The resonant frequency corresponds to the operating frequency as an antenna.

In the zero-order resonant antenna, when electric power at the operating frequency is supplied from the power supply point to the first conductor 11, the energy exchange between the inductor and the capacitor causes parallel resonance, generating an electric field perpendicular to the baseplate 2 at a position between the baseplate 2 and the first conductor 11. In other words, an electric field in the Z axis direction is generated. This vertical electric field propagates from the short-circuit element 13 towards the periphery of the first conductor 11. The vertical electric field is radiated into space as a vertically-polarized wave at the periphery of the first conductor 11. Note that the vertical polarization in the present disclosure refers to radio waves in which the oscillation direction of the electric field is perpendicular to the baseplate 2 and the first conductor 11, and can be referred to as baseplate vertical polarization or simply vertical polarization.

The direction of propagation of the vertical electric field generated by the above-described LC parallel resonance (in other words, zero-order resonance) is symmetrical with the short-circuit element 13 as the center, and thus has the same level of gain for all directions in the antenna horizontal plane. In other words, one metamaterial antenna is directional in all directions (360 degrees) from the center of the first conductor 11 to its periphery. The antenna horizontal plane in the present disclosure means a plane parallel to the baseplate 2 and the first conductor 11. In the present disclosure, the direction defined from the center of the first conductor 11 to its periphery may also be referred to as an antenna horizontal direction. The antenna horizontal direction is, according to another viewpoint, orthogonal to the Z axis direction and includes the X axis direction and the Y axis direction. The antenna horizontal direction corresponds, in short, to the lateral direction (in other words, side direction) for the antenna device 1.

Further, the operation of the antenna in transmitting (radiating) radio waves and the operation of the antenna in receiving radio waves are reversible with respect to each other. Although the above explanation is based on the example of radiating radio waves, the above configuration can receive vertically polarized waves arriving from the antenna horizontal direction.

By the way, in addition to the zero-order resonant antennas, another type of antenna that uses a metal plate facing a baseplate is a patch antenna. The patch antenna is an antenna that uses the resonance phenomenon caused by the path length of the electric current being λ/2, and is dissimilar to a zero-order resonant antenna in terms of its operation principle. Further, the operation principle of the patch antenna requires a radiating element to have a dimension of λ/2, while the zero-order resonant antenna does not require the first conductor 11 to have a length of λ/2. Further, the zero-order resonant antenna is dissimilar to the patch antenna also in terms of directivity. That is, the patch antenna and the plate inverted-F antenna forms a beam in the direction perpendicular to the baseplate (i.e., upward), whereas the zero-order resonant antenna basically forms a beam in the antenna horizontal direction, not in the antenna upward direction. Further, the patch antenna does not require a short-circuit element, whereas the zero-order resonant antenna requires a short-circuit element. Thus, in terms of operation principle, directivity, configuration, and the like, the zero-order resonant antenna is dissimilar to the patch antenna.

FIG. 4 shows the electric current distribution when the first power supply point 12 receives electric power and the first antenna 10 is operated. FIG. 4 shows that the electric current is distributed point-symmetrically around the center of the first conductor 11, i.e., around the short-circuit element 13. Note that P1 in FIG. 4 represents a value such as 10 dBA/m, 15 dBA/m, or 20 dBA/m, for example. P2 is a value greater than P1 by 20 dBA/m. The same applies to P1 and P2 shown in FIGS. 8 and 14 described below.

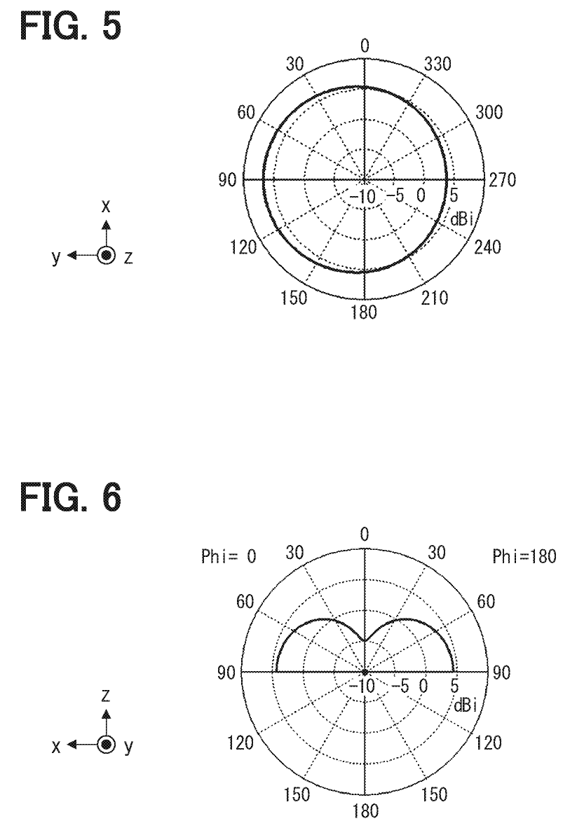

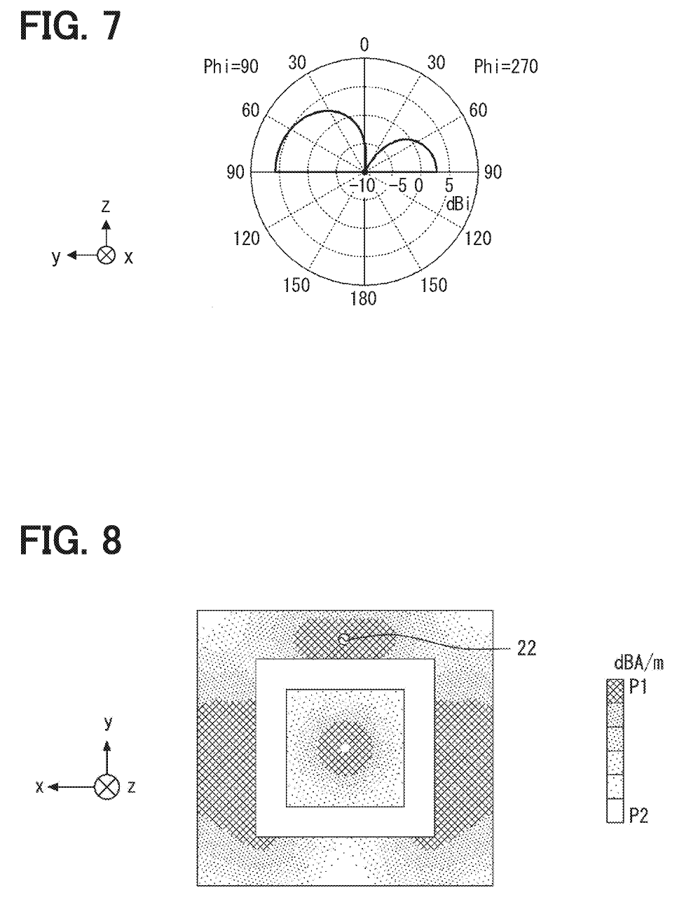

FIGS. 5, 6, and 7 show the directivity of the first antenna 10 when operated. FIG. 5 shows the directivity in the XY plane, or in other words, the antenna horizontal direction. FIG. 6 also shows the directivity in the XZ plane. Further, FIG. 7 shows the directivity in the YZ plane. As shown in FIGS. 5, 6, and 7, the first antenna 10 has the directivity in the horizontal direction, and generates null in the upward direction. In other words, the directivity of the first antenna 10 is orthogonal to the direction from the baseplate 2 to the first conductor 11. In the present disclosure, the direction orthogonal to the direction defined from the baseplate 2 to the first conductor 11 is also referred to as the antenna horizontal direction. The antenna horizontal direction means the direction defined from the center of the first conductor 11 to the periphery, or, putting it simple, the horizontal direction for the antenna device 1. Note that 0 degree shown in FIGS. 6 and 7 corresponds to the antenna upward direction, and the 90 degrees corresponds to the antenna horizontal direction. The same applies to FIGS. 10, 11, 16, 17, 20, and 21.

Operation of Second Antenna 20

The operation of the second antenna 20 is described here. In the present embodiment, the second antenna 20 is operated when the switching unit 3 switches the power supply point to the second power supply point 22. Since the length of the second antenna 20 in the Y axis direction (i.e., the second longitudinal length L2y) is set to λ/2, it is expected to operate as a patch antenna by forming standing waves of electric current and voltage in the second and third frame sections 21b and 21c during the supply of electric power. The radio wave in such case can be polarized with the direction of oscillation of the electric field parallel to the y-axis. Further, since the second antenna 20 operates as a patch antenna, the second antenna 20 is expected to form a beam in the positive direction of the Z-axis.

FIG. 8 shows the electric current distribution when the second power supply point 22 receives electric power and the second antenna 20 is operated. As shown in FIG. 8, the electric current is distributed along the direction of the second longitudinal length L2y, whose electrical length is half a wavelength of the given frequency. In other words, electric current standing waves are generated in the Y axis direction near the first frame section 21a and the second frame section 21b. This is the same as the electric current distribution of a typical patch antenna. In other words, the simulation shows that the antenna is operating as expected above.

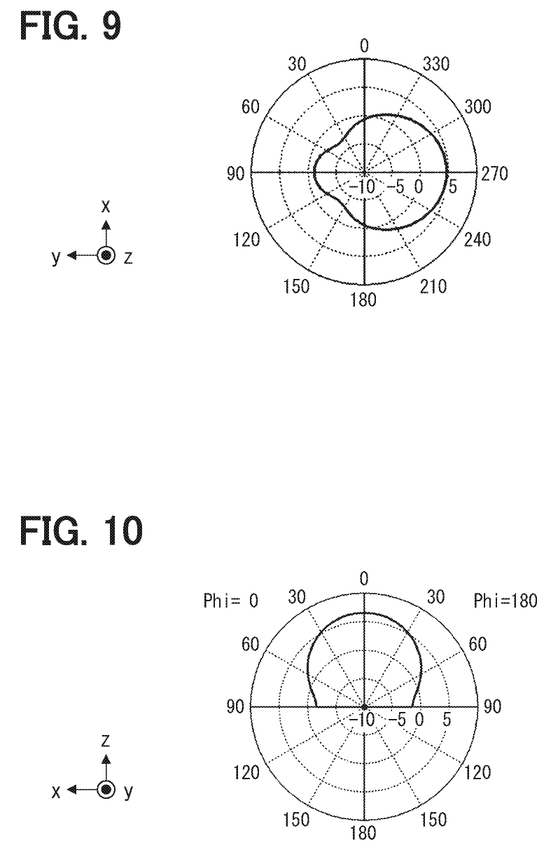

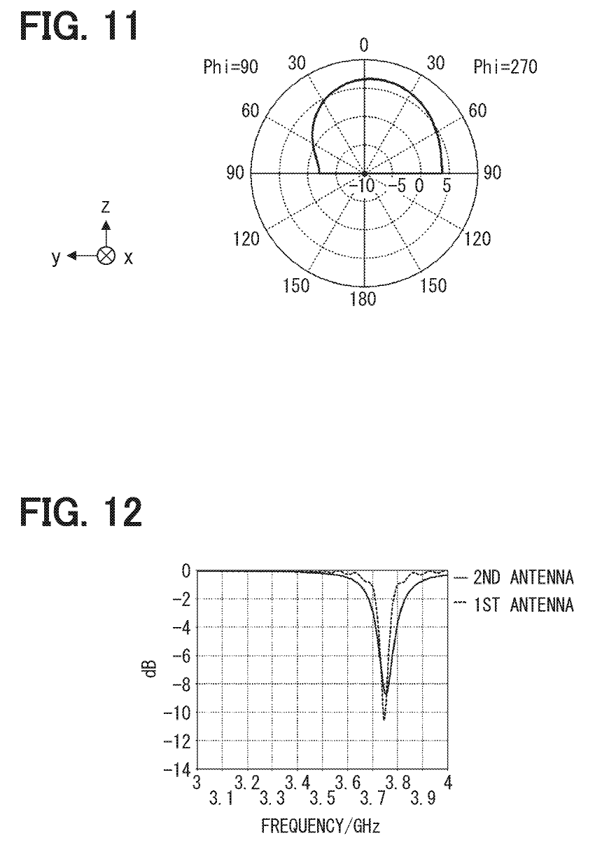

FIGS. 9, 10, and 11 show the directivity of the second antenna 20 when operated. FIG. 9 shows the directivity in the XY plane, or in other words, the antenna horizontal direction. FIG. 10 also shows the directivity in the XZ plane. Further, FIG. 11 shows the directivity in the YZ plane. As shown in FIGS. 9, 10, and 11, the directivity of the second antenna 20 is oriented in the upward direction. In other words, the directivity of the second antenna 20 is in the direction defined from the baseplate 2 to the second conductor 21.

FIG. 12 shows the simulated S-parameters (reflection characteristics) of the first antenna 10 and the second antenna 20, respectively. The horizontal axis of the graph shown in FIG. 12 represents frequency, and the vertical axis represents S11. The broken line shows S11 when the first antenna 10 is operated and the solid line shows S11 when the second antenna 20 is operated.

As the simulation results of the reflection characteristics in FIG. 12 show, S11 drops to –10 dB at around 3.75 GHz, i.e., at the target frequency, for the first antenna 10. Indirectly from this graph, it can be seen that the first antenna 10 is LC resonant (in other words, zero-order resonant) at the target frequency. Also, S11 of the second antenna 20 at 3.75 GHz is -8.5 dB. In general, an input reflection coefficient of –5 dB or less is often considered as a practicable configuration. As shown in the graph in FIG. 12, both of the first antenna 10 and the second antenna 20 are sufficiently practical as antennas for transmitting and receiving the target frequency.

Other analysis also confirmed that the correlation coefficient between the first antenna 10 and the second antenna 20 is 0.072. Such number is sufficiently high to be used as a MIMO. Further, the bit error rate (BER) while traveling at a vehicle speed of 60 km/h was also evaluated, and it was confirmed that the BER was about 0.05. In other words, according to the configuration of the present embodiment, sufficient communication quality is obtainable even during a travel of the vehicle.

### Summary of The First Embodiment

According to the configuration described above, the first antenna 10 has the directivity in the horizontal direction, and the second antenna 20 has the directivity in the upward direction. In other words, the directivity can be changed by 90 degrees by switching the power supply point to which electric power is supplied by the switching unit 3. Therefore, in case that the substrate 5 is mounted in an orientation parallel to the roof of a vehicle, the antenna is capable of communicating well with devices above and to the side of the vehicle, respectively. Further, when the present embodiment is applied to the Virtual MIMO, the antenna section 100, which is the antenna module provided in the antenna device 1, is substantially provided in the size of a single patch antenna, making it possible to perform MIMO in a smaller size.

### Second Embodiment

The present embodiment is a variation of the preceding embodiment in its basic form, and the description of the preceding embodiment can be used to support it. In the preceding embodiment, the outer shape of the second conductor 21 was rectangle; in the present embodiment, an outer shape of a second conductor 21 is square. A second lateral length L2x and a second longitudinal length L2y shall be values corresponding to the length of λ/2 of the radio wave at the target frequency.

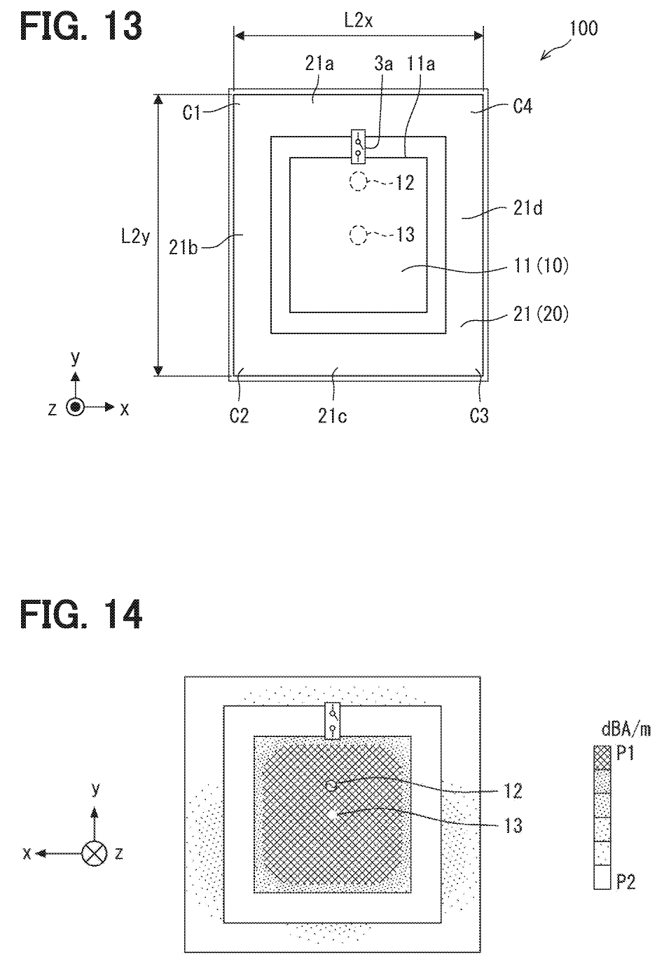

In the preceding embodiment, the switching unit 3 was set to switch the antenna to be operated by switching the power supply point to which electric power is supplied, but the antenna to be operated may also be switched by other methods. In the present embodiment, a switching unit 3 is configured to switch the antenna to be operated using a switch 3a, which is a switch, instead of using a second power supply point 22, as shown in FIG. 13. In other words, the switching unit 3 includes the switch 3a that electrically connects a first conductor 11 and a second conductor 21, and a controller 31 that controls the on/off of the switch 3a. For convenience, one of the four sides of the first conductor 11 that faces a first frame section 21a is referred to as a first side 11a. The first side 11a is a side among the two sides parallel to the X axis of the first conductor 11 that is relatively provided on the positive side of the Y axis. Hereafter, the sides of the first conductor 11 respectively facing the second, third, and fourth frame sections 21b, 21c, and 21d are also referred to as second, third, and fourth sides, in that order.

The switch 3a may be arranged to connect the first frame section 21a to the first side 11a. For example, the switch 3a connects the center of each of the first side 11a and the first frame section 21a in the X axis direction. Thus, in the present embodiment, the connection point of the switch 3a to the second conductor 21 is near the center of the first frame section 21a in the X axis direction.

The switch 3a may be a simple switch or may be other type switch that is capable of turning the electrical connection on and off. For example, a diode may electrically connect the first side 11a to the second conductor 21. In such case, a DC power supply is connected in parallel with the diode. Further, the controller 31 may also turn on and off the electrical connection between the first conductor 11 and the second conductor 12 by turning on and off its DC power supply.

When the switch 3a is off, the first conductor 11 and the second conductor 21 are non-conducting, thereby the electric current flowing into the conductor 11 from the first power supply point 12 does not flow through to the second conductor 21, but is consumed within the first antenna 10. That is, when the switch 3a is off, the first antenna 10 operates and the second antenna 20 does not operate. On the other hand, when the switch 3a is on, electric current from the first power supply point 12 can flow through the first conductor 11 to the second antenna 20. Patch antennas are more likely to operate electrically than metamaterial antennas, due to impedance or for other reasons. Thus, when the switch 3a is on, electric current flowing from the first power supply point 12 into the first conductor 11 flows into the first frame section 21a of the second conductor 21, causing the second antenna 20 to operate primarily.

Specifically, when the switch 3a is on, electric current flowing from the switch 3a into the first frame section 21a propagates toward the second frame section 21b and the fourth frame section 21d. When the second and fourth frame sections 21b and 21d are λ/2, standing waves are formed in the second and fourth frame sections 21b and 21d, and those sections can operate as patch antennas.

### Verification of Operation of The Second Embodiment

As described above, in the present embodiment, the first antenna 10 is expected to operate when the switching unit 3 is off and the second antenna 20 is expected to operate when the switching unit 3 is on.

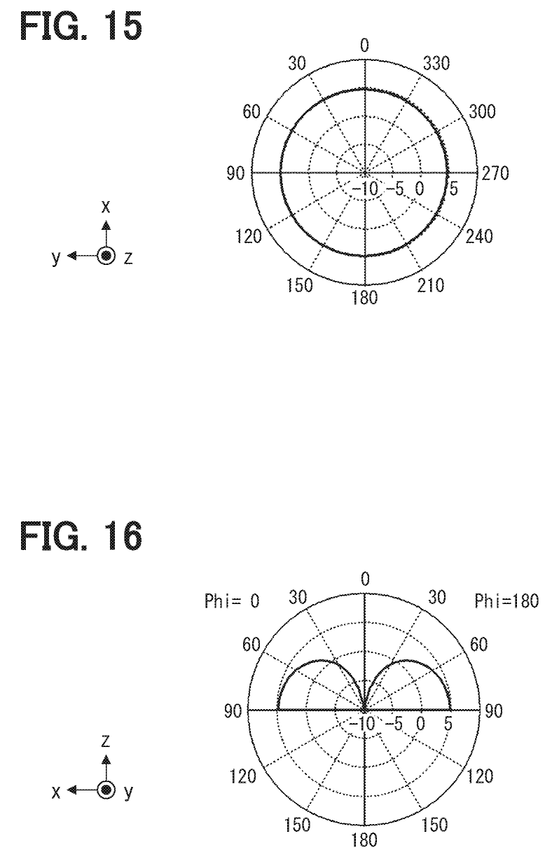

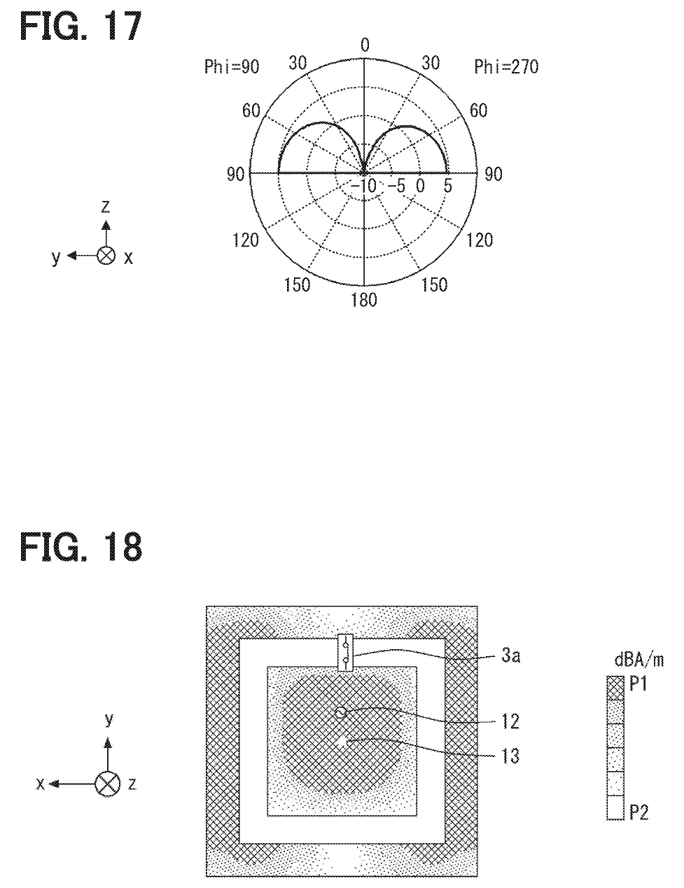

FIG. 14 shows the electric current distribution when the switch 3a is turned off. As shown in FIG. 14, the electric current is distributed point-symmetrically around the center of the first conductor 11, that is, around the short-circuit element 13. FIGS. 15, 16, and 17 show the directivity when the switch 3a is turned off. FIG. 15 shows the directivity on the XY plane, or in other words, in the antenna horizontal direction. FIG. 16 shows the directivity on the XZ plane. Further, FIG. 17 shows the directivity on the YZ plane. As shown in FIG. 15, FIG. 16, and FIG. 17, the first antenna 10 is directed horizontally and is nulls in the upward direction. In other words, the directivity of the first antenna 10 is in an antenna horizontal direction. These current distributions and directivities indicate that the first antenna 10 operates as a zero-order resonant antenna when the switch 3a is turned off.

On the other hand, FIG. 18 shows the electric current distribution when the switch 3a is turned on. As shown in FIG. 18, electric current is distributed along the direction of the second longitudinal length L2y, whose electrical length is a half wavelength of a given frequency. In other words, electric current standing waves are generated in the Y axis direction near the first frame section 21a and the second frame section 21b. This is because electric current flows from the first conductor 11 through the switch 3a to the first frame section 21a, and from the first frame section 21a to the second frame section 21b and the fourth frame section 21d.

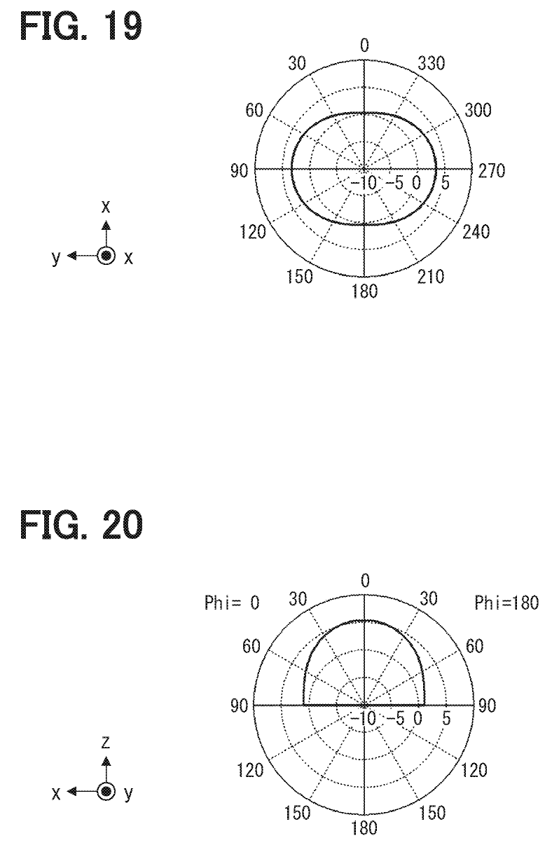

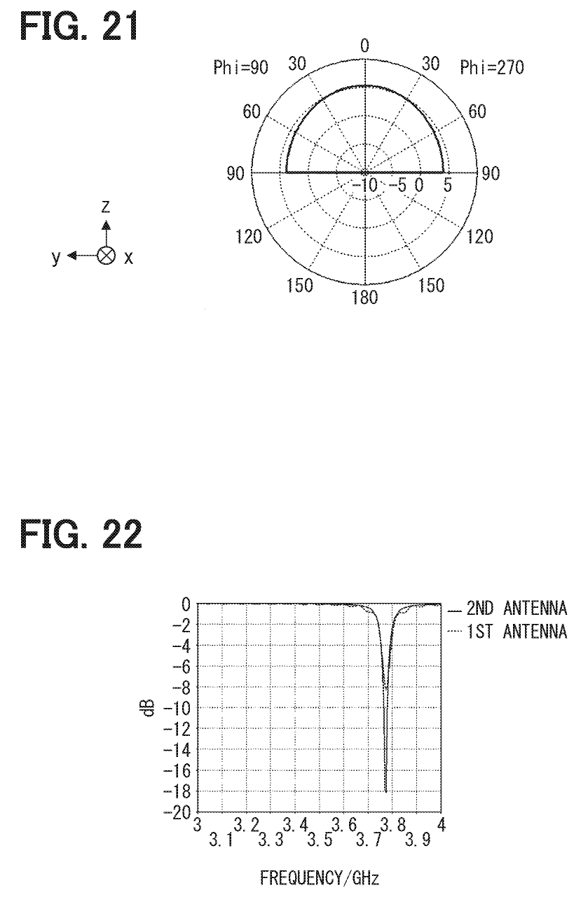

FIGS. 19, 20, and 21 show the directivity when the switch 3a is turned on. FIG. 19 shows the directivity on the XY plane, or in other words, the antenna horizontal direction. FIG. 20 shows the directivity on the XZ plane. Further, FIG. 21 shows the directivity on the YZ plane. As shown in FIG. 19, FIG. 20, and FIG. 21, the directivity of the second antenna 20 is oriented in the upward direction. By turning on the switch 3a in the above-described manner, it is understood that the second conductor 21 is operating as a patch antenna.

FIG. 22 shows the simulated S-parameters (reflection characteristics) when the switch 3a is on and off. For convenience, the simulation reproduced the on/off of the switch 3a by changing the magnitude of the resistance between the first conductor 11 and the second conductor 12. Specifically, 0.1 ohms is set when the switching unit 3 is on, and 5 M ohms is set when the switching unit 3 is off. In FIG. 22, the horizontal axis of the graph represents frequency, and the vertical axis of the graph represents S11. The broken line in FIG. 22 shows S11 when the first antenna 10 is operated, and the solid line shows S11 when the second antenna 20 is operated.

As the simulation results of the reflection characteristics in FIG. 22 show, the first antenna 10 has an LC resonance (in other words, a zero-order resonance) at a given frequency around 3.75 GHz. The S11 of the first antenna 10 at 3.75 GHz is –18 dB, which is sufficient for practical use as an antenna for transmitting and receiving a given frequency. Further, the S11 of the second antenna 20 is –8 dB, which also shows that the antenna is sufficiently practical for transmitting and receiving a given frequency.

In the simulation, the correlation coefficient between the first antenna 10 and the second antenna 20 was 0.415. Further, from the test of the bit error rate (BER) during a travel at a speed of 60 km/h, it was confirmed that the BER was about 0.05, similar to the one in the first embodiment. From the present embodiment, it is also expected that the antenna provides sufficient communication quality during the travel of the vehicle.

### Summary of The Second Embodiment

According to the present embodiment, the directivity can be changed by 90 degrees as in the preceding embodiment. Further, compared to the configuration of the first embodiment, the number of power supply points provided for the antenna device 1 is reducible, and the circuit configuration can further be simplified.

### Third Embodiment

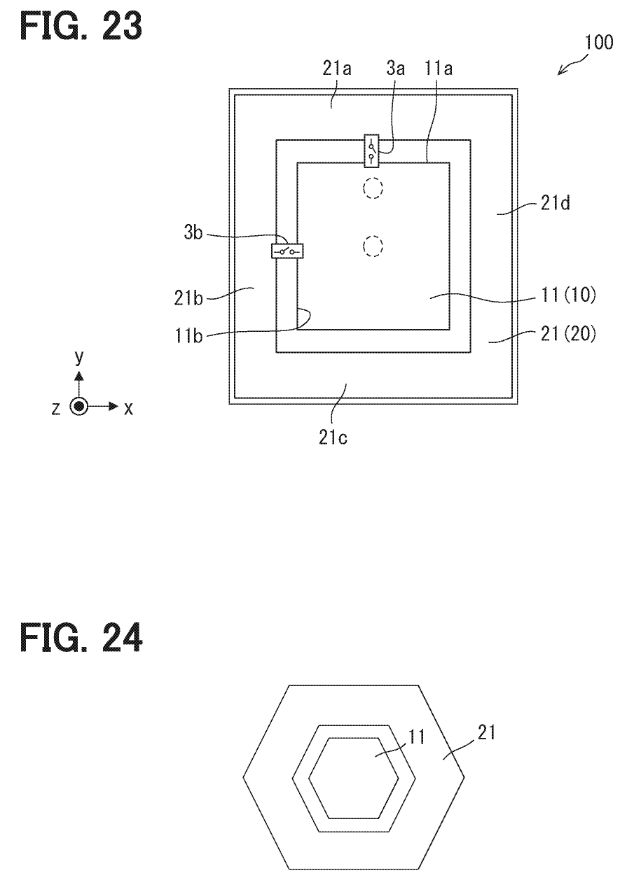

The present embodiment may be understood as a variation of the preceding embodiment in its basic form. The description of the preceding embodiments may be used to support the present embodiment. In the second embodiment, there was one switch that electrically connects the first side 11a and the second conductor 21 as the switching unit 3, but two or more switches may be provided. In the present embodiment, as shown in FIG. 23, the switching unit 3 has a second switch 3b in addition to a first switch 3a, which corresponds to the switch 3a in the second embodiment.

The first switch 3a is configured to electrically connect a first conductor 11 and a second conductor 21 at a predetermined position. The second switch 3b is configured to electrically connect the first conductor 11 to the second conductor 21 at a different position than the first switch 3a.

The first switch 3a connects the first side 11a and a first frame section 21a, as in the second embodiment. The second switch 3b is configured to electrically connect a second side 11b facing a second frame section 21b and the second frame section 21b. The second side 11b is a side among the two sides parallel to the Y axis of the first conductor 11 that is relatively provided on the negative side of the X axis.

The first switch 3a connects approximately the center of each of the first side 11a and the first frame section 21a in the X axis direction. The second switch 3b connects approximately the center of each of the second side 11b and the second frame section 21b in the Y axis direction.

The first switch 3a and the second switch 3b may be simple switches or may be other type switches turning the electrical connection on and off, as in the second embodiment.

In the present embodiment, the second antenna 20 does not have a second power supply point 22. Alternatively, by switching on the first switch 3a and the second switch 3b, the electric power from the first power supply point 12 is supplied through the first conductor 11 to the second antenna 20.

When both of the first switch 3a and the second switch 3b are off, the first conductor 11 and the second conductor 12 are non-conducting, thereby electric current flowing into the first conductor 11 from the first power supply point 12 does not flow to the second conductor 21 and is consumed in the first antenna 10. That is, when the first switch 3a and the second switch 3b are off, the first antenna 10 operates and the second antenna 20 does not operate.

When at least one of the first switch 3a and the second switch 3b is on, electric current from the first power supply point 12 can flow through the first conductor 11 to the second antenna 20. As in the second embodiment, when at least one of the first switch 3a and the second switch 3b is on, electric current from the first power supply point 12 flows mainly to the second conductor 21, allowing the second antenna 20 to operate primarily. The details are described as follows.

### Operational Characteristics of The Third Embodiment

In this configuration, the first antenna 10 is operated when the first switch 3a and the second switch 3b are both off. When at least one of the first switch 3a and the second switch 3b is on, the second antenna 20 is operated.

The operation of the first antenna 10 when the first switch 3a and the second switch 3b are both off is the same as in the second embodiment. Further, the operation of the second antenna 20 when only the first switch 3a is on is the same as in the second embodiment. In other words, when the first switch 3a is on and the second switch 3b is off, standing waves are generated at the second and fourth frame sections 21b and 21d, and the antenna operates as a patch antenna. When only the first switch 3a is on, the polarization is in the Y axis direction, as shown in FIG. 18.

The electric current distribution when only the second switch 3b is on is the electric current distribution in the second form (FIG. 18) rotated 90 degrees counterclockwise in the XY coordinate system. That is, when the first switch 3a is off and the second switch 3b is on, standing waves are generated in the first and third frame sections 21a and 21c, and the second antenna 20 operates as a patch antenna. The polarization in such case is in the X axis direction. Likewise, the directivity is rotated 90 degrees counterclockwise in the XY coordinate system from the system shown in FIG. 19, FIG. 20, and FIG. 21.

The electric current distribution when both switches, the first switch 3a and the second switch 3b, are on is an average of the electric current distributions of (i) when only the first switch 3a is on and (ii) when only the second switch 3b is on. As a result, the directivity of when both of the first switch 3a and the second switch 3b are on is an average of (i) the directivity when only the first switch 3a is on and (ii) the directivity when only the second switch 3b is on. In other words, the directivity of a situation described above is in the upward direction.

Note that, in the simulation, the correlation coefficient between (i) an antenna model corresponding to a state in which only the first switch 3a is on and (ii) an antenna model corresponding to a state in which only the second switch 3b is on is 0.175. The correlation coefficient between (i) a model corresponding to a state in which only the first switch 3a is on and a model corresponding to a state in which both of the first switch 3a and the second switch 3b are on is 0.61.

### Modification Example

The second antenna 20 is shown as an example configured to operate as a patch antenna, but the present disclosure is not limited to the above. The second antenna 20 may be any antenna with larger dimensions than the first antenna 10. For example, the second antenna 20 may be a loop antenna.

The first antenna 10 is shown in an example of a rectangular shape, but the present disclosure is not limited to the above. For example, the shape of the first antenna 10 may be polygonal, or hexagonal, as shown in FIG. 24.

### Other Embodiments

The disclosure in the present specification, drawings, and the like, is not limited to the illustrated embodiments. The disclosure encompasses the illustrated embodiments and variations by those skilled in the art based thereon. For example, the disclosure is not limited to the combination of parts and/or elements shown in the embodiments. The disclosure can be implemented through a variety of combinations. The disclosure may have additional parts that can be added to the embodiment. The disclosure encompasses omission of parts and/or elements from the embodiments. The disclosure encompasses the substitution or combination of parts and/or elements between one embodiment and another. The technical scope of the disclosure is not limited to the description of the embodiments. The several technical scopes disclosed are indicated by the statement of claims and should be further interpreted to include all modifications within the meaning and scope equivalent to the statement of claims.

The disclosure in the specification, drawings, and the like, is not limited by the claims. The disclosures in the specification, drawings, and the like encompass the technical ideas described in the claims, and further extend to technical ideas that are more diverse and broader than those described in the claims. Therefore, various technical ideas can be extracted from the disclosure of the specification, drawings, and the like, without being bound by the description of the claims.

### Disclosure of Technical Ideas

The specification discloses several technical ideas, which are described in several items listed below. Some items may be listed in a multiple dependent form, in which the preceding item is selectively cited in the subsequent item. Further, some items may be listed by a multiple dependent form referring to another multiple dependent form. The items listed in these multi-item dependent forms define multiple technical ideas.

The present disclosures include at least one of the following exemplars.

According to a first exemplar of the present disclosure, an antenna device includes: a baseplate (2); a first antenna (10) including a first conductor (11), which is a flat conductor positioned to face the baseplate, and a short-circuit element (13) electrically connecting the first conductor and the baseplate, the first antenna being configured to operate as a zero-order resonant antenna; a second antenna (20) including a second conductor (21) arranged to surround the first conductor; and a switching unit (3) configured to switch one antenna to be operated among the first antenna and the second antenna. The second antenna may be configured to operate in a same frequency band as the first antenna.

According to the antenna device of a second exemplar of the present disclosure, the first conductor may be provided with a first power supply point (12), the second conductor my be provided with a second power supply point (22), which is separated and different from the first power supply point, and the switching unit may be configured to switch one power supply point to which electric power is supplied among the first power supply point and the second power supply point.

According to the antenna device of a third exemplar of the present disclosure, the first conductor may be provided with a first power supply point (12). In this case, the switching unit may include a switch (3a) configured to electrically connect the first conductor and the second conductor, and a controller (31) configured to switch a connection state of the switch to switch the one antenna to be operated.

According to the antenna device of a fourth exemplar of the present disclosure, the switching unit may include a first switch (3a) that is configured to electrically connect the first conductor and the second conductor, a second switch (3b) that is a switch different from the first switch and is configured to electrically connect the first conductor and the second conductor, and a controller (31) configured to switch a connection state of each of the first switch and the second switch. In this case, the first switch may be configured to electrically connect the first conductor and the second conductor at a predetermined position, and the second switch may be configured to electrically connect the first conductor and the second conductor at a position different from the first switch.

According to the antenna device of a fifth exemplar of the present disclosure, the first conductor may have a rectangle shape with four sides including a first side and a second side that is orthogonal to the first side. In this case, the switching unit may include a first switch (3a) that is configured to electrically connect the first conductor and the second conductor, a second switch (3b) that is a switch different from the first switch and is configured to electrically connect the first conductor and the second conductor, and a controller (31) configured to switch a connection state of each of the first switch and the second switch. In addition, the first switch may be configured to electrically connect the first side (11a) of the first conductor and the second conductor, and the second switch may be configured to electrically connect the second side (11b) of the first conductor and the second conductor.

According to the antenna device of a sixth exemplar of the present disclosure, the first antenna may be configured to be parallel-resonant in the frequency band, using an inductance provided by the short-circuit element and a capacitance formed by the baseplate and the first conductor.

According to the antenna device of a seventh exemplar of the present disclosure, the second conductor may be configured to have a length of half a wavelength of a radio wave in the frequency band in a first direction, and the first conductor may be configured to have (i) a first length in the first direction that is shorter than the half of the wavelength of the radio wave in the frequency band and (ii) a second length in a second direction that is a direction orthogonal to the first direction and is shorter than a length of the second conductor in the second direction.

According to the antenna device of an eighth exemplar of the present disclosure, the first antenna may be an antenna with a directivity oriented in a direction orthogonal to a direction defined from the baseplate to the first conductor, and the second antenna may be an antenna with a directivity oriented in a direction defined from the baseplate to the second conductor.

What is claimed is:

1. An antenna device comprising:
a baseplate;
a first antenna including a first conductor, which is a flat conductor positioned to face the baseplate, and a short-circuit element electrically connecting the first conductor and the baseplate, the first antenna being configured to operate as a zero-order resonant antenna;
a second antenna including a second conductor arranged to surround the first conductor; and
a switching unit configured to switch one antenna to be operated among the first antenna and the second antenna, wherein
the second antenna is configured to operate in a same frequency band as the first antenna.

2. The antenna device of claim 1, wherein
the first conductor is provided with a first power supply point,
the second conductor is provided with a second power supply point, which is separated and different from the first power supply point, and
the switching unit is configured to switch one power supply point to which electric power is supplied among the first power supply point and the second power supply point.

3. The antenna device of claim 1, wherein
the first conductor is provided with a first power supply point,
the switching unit includes
a switch configured to electrically connect the first conductor and the second conductor, and
a controller configured to switch a connection state of the switch, and
the controller controls the connection state of the switch, to switch the one antenna to be operated.

4. The antenna device of claim 1, wherein
the switching unit includes
a first switch that is configured to electrically connect the first conductor and the second conductor,
a second switch that is a switch different from the first switch, and is configured to electrically connect the first conductor and the second conductor, and
a controller configured to switch a connection state of each of the first switch and the second switch,
the first switch is configured to electrically connect the first conductor and the second conductor at a predetermined position, and
the second switch is configured to electrically connect the first conductor and the second conductor at a position different from the first switch.

5. The antenna device of claim 1, wherein
the first conductor has a rectangle shape with four sides including a first side and a second side that is orthogonal to the first side,
the switching unit includes
a first switch that is configured to electrically connect the first conductor and the second conductor,
a second switch that is a switch different from the first switch, and is configured to electrically connect the first conductor and the second conductor, and
a controller configured to switch a connection state of each of the first switch and the second switch,
the first switch is configured to electrically connect the first side of the first conductor and the second conductor, and
the second switch is configured to electrically connect the second side of the first conductor and the second conductor.

6. The antenna device of claim 1, wherein
the first antenna is configured to be parallel-resonant in the frequency band, using an inductance provided by the short-circuit element and a capacitance formed by the baseplate and the first conductor.

7. The antenna device of claim 1, wherein
the second conductor is configured to have a length of half a wavelength of a radio wave in the frequency band in a first direction, and
the first conductor is configured to have (i) a first length in the first direction that is shorter than the half of the wavelength of the radio wave in the frequency band and (ii) a second length in a second direction that is a direction orthogonal to the first direction and is shorter than a length of the second conductor in the second direction.

8. The antenna device of claim 1, wherein
the first antenna is an antenna with a directivity oriented in a direction orthogonal to a direction defined from the baseplate to the first conductor, and
the second antenna is an antenna with a directivity oriented in a direction defined from the baseplate to the second conductor.
